(19) United States
(12) Patent Application Publication
(10) Pub. No.: US 2008/0229240 A1
(43) Pub. Date: Sep. 18, 2008

(54) Finding Pages Based on Specifications of Locations of Keywords

(76) Inventors: Zachary Adam Garbow, Rochester, MN (US); Bryan Mark Logan, Rochester, MN (US); Terrence Theodore Nixa, Rochester, MN (US); Kevin Glynn Paterson, San Antonio, TX (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/686,574

(22) Filed: Mar. 15, 2007

(51) Int. Cl. G06F 3/048

(52) U.S. Cl. 715/810

(57) ABSTRACT

A palette is displayed that includes widgets. A specification of a first widget selected from among the widgets in the palette is received along with a first widget location, a keyword, and a keyword location. Pages are found that, when rendered, include a term located at a term location and an element located at a respective element location, where the term matches the keyword and the element matches the first widget. In various embodiments, the identifiers of the pages are sorted based on distances between the first widget location and the element location, distances between the keyword location and the term location, differences between widths and heights of the first widget and the element, and/or based on matches between the visual attribute for the first widget and a visual characteristic for the element.

### FIELD

An embodiment of the invention generally relates to finding pages based on specifications of locations of keywords.

### BACKGROUND

Years ago, computers were isolated devices that did not communicate with each other. But, today computers are often connected in networks, such as the Internet or World Wide Web, and a user at one computer, often called a client, may wish to access information at multiple other computers, often called servers, via a network. Information is often stored at servers and sent to the clients in units of pages, which are connected together via embedded hyperlinks or links. A link is an address, such as a URL (Uniform Resource Locator) of a linked page that is embedded in a linking page that, when selected, causes the linked page to be retrieved. Because the Internet includes so many pages, finding a page of interest can be difficult, so several companies provide search engines that allow users to search for pages that contain keywords.

These search engines typically allow the entry of keywords, which are weighted and searched for within an index of pages. The search engines examine the index for instances of terms that match the keyword, taking into account metadata associated with the pages and the context surrounding the terms in the pages, which provide a different relevance for terms that appear in different portions of a page, e.g., in a header or title, as opposed to a paragraph or link.

The aforementioned searching techniques work well for computers, which can quickly parse the type of information contained within the page. Unfortunately, they are less useful to humans, whose brains provide very powerful visual pattern matching capabilities, but are not as adept at analyzing text. Users may remember the visual context surrounding a phrase or keyword within a page for which they are searching, but not the meta information associated with it. Also, users may desire to find a set of pages that contain a certain format that appeals to them aesthetically or is more apt to contain relevant information for their search. As such, current search techniques are insufficient for searches that are visual by nature.

Thus, what is needed is an enhanced technique for searches that are visual in nature.

### SUMMARY

A method, apparatus, system, and storage medium are provided. In an embodiment, a palette is displayed that includes widgets. A specification of a first widget selected from among the widgets in the palette is received along with a first widget location, a keyword, and a keyword location. Pages are found that, when rendered, include a term located at a term location and an element located at a respective element location, where the term matches the keyword and the element matches the first widget. In various embodiments, the identifiers of the pages are sorted based on distances between the first widget location and the element location, distances between the keyword location and the term location, differences between widths and heights of the first widget and the element, and/or based on matches between the visual attribute for the first widget and a visual characteristic for the element.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example search outline user interface, according to an embodiment of the invention.

FIG. 3 depicts a block diagram of an example user interface for a search request using an outline, according to an embodiment of the invention.

FIG. 4 depicts a block diagram of example pages, according to an embodiment of the invention.

FIG. 5 depicts a block diagram of an example data structure for an index, according to an embodiment of the invention.

FIG. 6 depicts a flowchart of example processing for a crawler, according to an embodiment of the invention.

FIG. 7 depicts a flowchart of example processing for building an outline, according to an embodiment of the invention.

FIG. 8 depicts a flowchart of example processing for searching using an outline, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

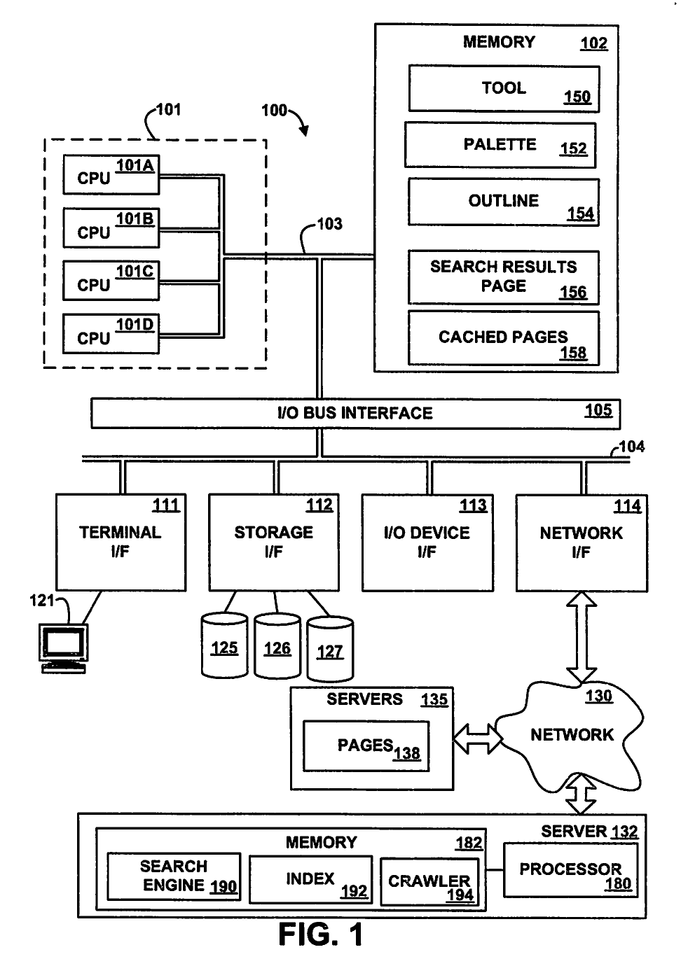

Referring to the Drawings, wherein like numbers denote like parts throughout the several views, FIG. 1 depicts a high-level block diagram representation of a client computer system 100 connected to server computer systems 132 and 135 via a network 130, according to an embodiment of the present invention. The terms “client” and “server” are used herein for convenience only, and in various embodiments a computer system that operates as a client in one environment may operate as a server in another environment, and vice versa. In an embodiment, the hardware components of the computer systems 100, 132, and 135 may be implemented by IBM System i5 computer systems available from International Business Machines Corporation of Armonk, N.Y. But, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes a tool 150, a palette 152, an outline 154, a search results page 156, and cached pages 158. Although the tool 150, the palette 152, the outline 154, the search results page 156, and the cached pages 158 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the tool 150, the palette 152, the outline 154, the search results page 156, and the cached pages 158 are illustrated as being contained within the main memory 102, these elements are not necessarily all completely contained in the same storage device at the same time. Further, although the tool 150, the palette 152, the outline 154, the search results page 156, and the cached pages 158 are illustrated as being separate entities, in other embodiments some of them, portions of some of them, or all of them may be packaged together.

The tool 150 creates the palette 152 and the outline 154 and displays them via the terminal 121. The palette 152 includes a toolbox of widgets that a user may use to construct the outline 154 by sending requests to the tool 150. The outline 154 includes a visual arrangement of widgets, widget locations within the outline, keywords, keyword locations within the outline, and visual attributes of the widgets, which together form a search request. The visual attributes of the widgets may include indications of whether or not the widgets are displayed blinking or flashing, display fonts for the widgets, colors for the widgets, and indications of whether or not the widgets include hyperlinks, pointers, or embedded links to other pages. The tool 150 sends the outline 154 to the server computer system 132. The server computer system 132 performs the search request represented by the outline 154 and sends the search results page 156 to the tool 150. The tool 150 receives the search results page 156 from the server computer system 132 and displays the search results page 156 via the terminal 121. In various embodiments, the tool 150 may be implemented via an operating system, a user application, a third-party application, a browser, a plug-in for a browser, any combination thereof, or any appropriate program encoded with executable instructions or interpretable statements for execution on the processor 101. In another embodiment, the tool 150 may be implemented in hardware. Since, as explained above, the tool 150 may include a combination of components, one component (e.g., the browser) may perform one action, such as retrieval of pages, while another component (e.g., the plug-in) sends requests for searches to the server computer system 132. The cached pages 158 includes pages previously retrieved from the server computer systems 135.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, which may include user output devices (such as a video display device or speaker) and user input devices (such as a keyboard, mouse, touchpad, trackball, light pen, or other pointing device). The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types, such as printers or fax machines. The network interface 114 provides one or more communications paths from the computer system 100 to other digital devices and computer systems 132 and 135; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user “mainframe” computer system, a single-user system, or a server or similar device that has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100, the server computer systems 132, and the server computer systems 135. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The server computer system 132 may include some or all of the hardware components previously described above as being included in the client computer system 100. The server computer system 132 includes memory 182 connected to a processor 180. The memory 182 is a random access semiconductor memory or other storage device that stores or encodes a search engine 190, an index 192, and a crawler 194.

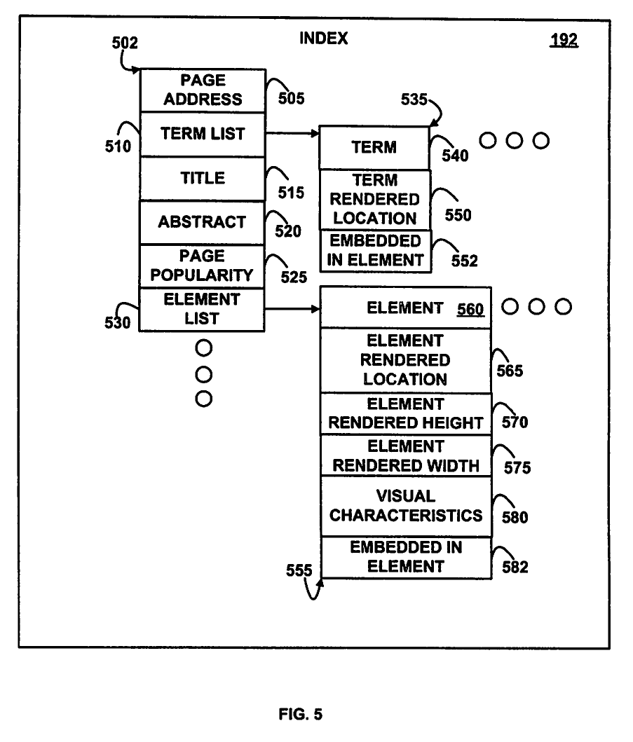

The crawler 194 (also called a spider, robot, or agent) visits a page at the server computer system 135, reads it, and then follows links to other pages within the same domain or web site. The crawler 194 typically returns to the site on a regular basis, such as every month or other time period, to look for changes. The crawler 194 stores selected information it finds into the index 192, which represents the pages at the server computer systems 135. The index 192 is further described below with reference to FIG. 5. Sometimes, new pages or changes that the crawler 194 finds may take some time to be added to the index 192. Thus, a web page may have been “crawled” but not yet “indexed.” Until the page has been added to the index 192, the page is not available to those searching with the search engine 190.

The search engine 190 receives a search request, in the form of the outline 154, from the tool 150. The search engine 190 reads information about the pages that are described in the pre-created index 192 to search for pages that include terms that match the search keywords, where those terms are further located at the same or near relative locations within the pages as the relative locations of the keywords within the outline 154. The search engine 190 further searches for pages that include elements that match the widget, where those elements are further located at the same or near relative locations within the pages as the relative locations of the widget within the outline 154. The search engine 190 further searches for pages that include elements that have visual characteristics that match the visual attributes that are specified by the search request. The search engine 190 creates the search results page 156 and adds identifiers of the pages that it finds to the search results page 156.

The search engine 190 sorts the identifiers in the search results page 156 based on the distances between the widget locations within the rendered outline 154 and the element locations within the rendered pages 138, with the identifiers of the pages 138 that have the shorter distances listed nearer the beginning or higher in the sort order of the search results page 156. The search engine 190 further sorts the identifiers in the search results page 156 based on the distances between the keyword locations within the rendered outline 154 and the term locations within the rendered pages 138, with the identifiers of the pages 138 that have the shorter distances listed nearer the beginning or higher in the search order of the search results page 156. The search engine 190 further sorts the identifiers based on the differences between widths and heights of the widgets in the rendered outline 154 and the widths and heights of the elements in the rendered pages 138, with the identifiers of the pages 138 that include elements with widths and heights that are nearest to the widths and heights (the least different) of the widgets listed nearer the beginning or higher in the search order of the search results page 156.

The search engine 190 further sorts the identifiers based on how closely the visual attributes specified by the search request match the visual characteristics of the elements in the rendered pages, with the identifiers of the pages that include elements with visual characteristics that match the visual attributes of the widgets listed nearer the beginning of the search results page 156 than the pages that include elements with visual characteristics that do not match the visual attributes of the widgets. Thus, the search engine 190 sorts the identifiers of the pages in the search results page 156, so that the pages 138 that have the closer visual appearance to the outline 154 are listed nearer the beginning or higher in the search results than pages 138 with a visual appearance that is farther from the visual appearance of the outline 154. The search engine 190 returns the search results page 156 to the tool 150, which displays the search results page 156 via the terminal 121.

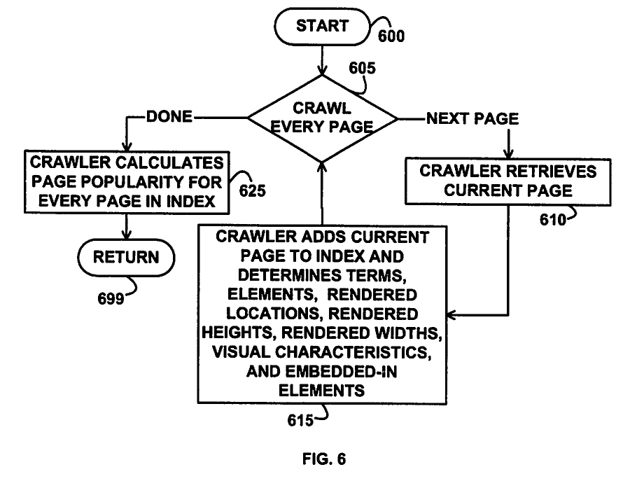

In an embodiment, the crawler 194 and/or the search engine 190 include instructions capable of executing on the processor 180 or statements capable of being interpreted by instructions executing on the processor 101 to perform the functions as further described below with reference to FIGS. 6, 7, and 8. In another embodiment, the crawler 194 and/or the search engine 190 may be implemented in microcode. In another embodiment, the crawler 194 and/or the search engine 190 may be implemented in hardware via logic gates and/or other appropriate hardware techniques.

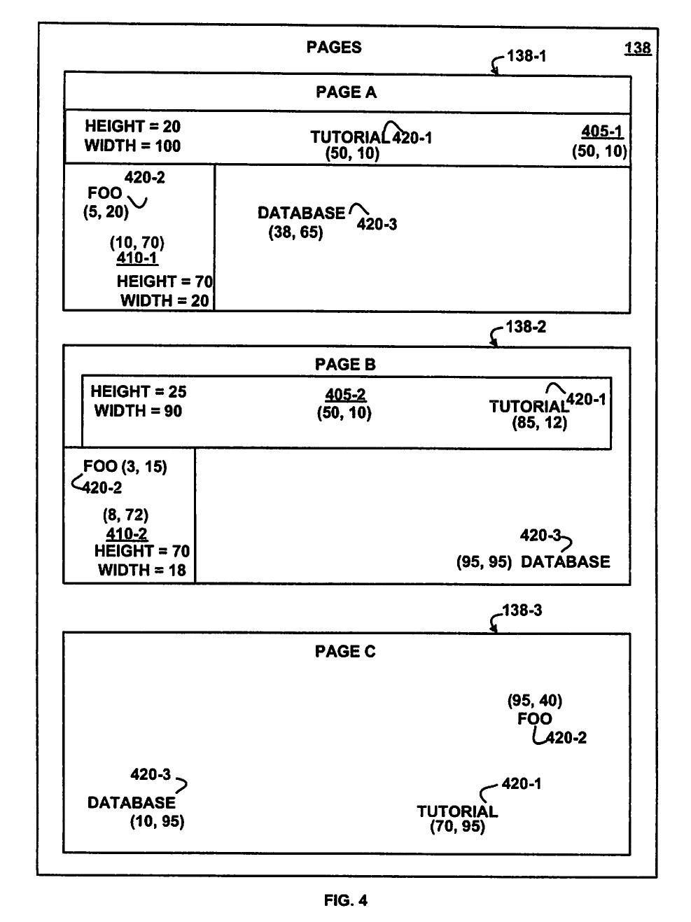

The server computer systems 135 may include some or all of the hardware components previously described above as being included in the computer system 100. The server computer systems 135 include pages 138 stored in memory with a similar description as the main memory 102. The pages 138 may include any appropriate content that is capable of being crawled via the crawler 194 and retrieved via the tool 150, such as text, video, audio, images, control tags, formatting tags, statements, or any other appropriate data. In various embodiments, the pages 138 may be implemented via documents, files, objects, tables, databases, directories, subdirectories, or any portion or combination thereof and in some embodiments may include embedded control tags, format information, statements, or logic in addition to data. Examples of the pages 138 are further described below with reference to FIG. 4.

It should be understood that FIG. 1 is intended to depict the representative major components of the client computer system 100, the network 130, the server computer systems 132, and the server computer systems 135 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., and are referred to hereinafter as “computer programs,” or simply “programs.” The computer programs typically comprise one or more instructions that are resident at various times in various memory and storage devices in the client computer system 100 and/or the server computer system 132, and that, when read and executed by one or more processors in the client computer system 100 and/or the server computer system 132, cause the client computer system 100 and/or the server computer system 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the client computer system 100 and/or the server computer system 132 via a variety of tangible signal-bearing media that may be operatively or communicatively connected (directly or indirectly) to the processor or processors, such as the processor 101 and 180. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102 or 182, CD-RW, or diskette; or

(3) information conveyed to the client computer system 100 and/or the server computer system 132 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

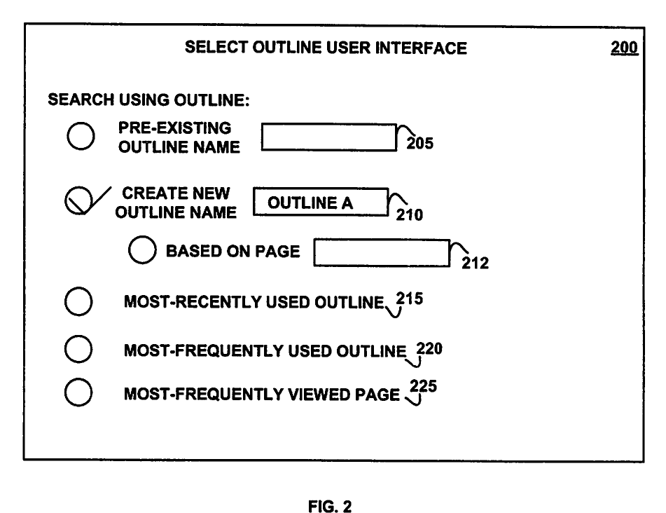

FIG. 2 depicts a block diagram of an example search outline user interface 200, according to an embodiment of the invention. The tool 150 displays the example search outline user interface 200 via the user terminal 121. The example search outline user interface 200 includes a pre-existing outline name option 205, a create new outline name option 210 with a based on page sub-option 212, a most-recently used outline option 215, a most-frequently used outline option 220, and a most-frequently viewed page outline option 225.

In response to selection of the pre-existing outline name option 205, the tool 150 opens and displays the specified outline. In response to selection of the create new outline name option 210, the tool 150 creates and displays the specified new outline. If the based-on page option 212 is selected, the tool 150 receives the name, address, or other identifier of the specified page, retrieves the specified page (from the cached pages 158 or the pages 138 at the server computer systems 135), reads embedded elements from the specified page, creates the new outline with widgets corresponding to the embedded elements, and creates the widgets in the outline at locations corresponding to the locations of the embedded elements in the specified page. In response to selection of the most-recently used outline option 215, the tool 150 finds, opens, and displays the outline that was most-recently used or accessed in time, as compared to the current time.

In response to selection of the most-frequently used outline option 220, the tool 150 opens the outline that was accessed, open, or used the most number of times, as compared to the number of times that other outlines were accessed, opened, or used.

In response to selection of the most-frequently viewed page outline option 225, the tool 150 finds the page in the page cache 158 that was retrieved, viewed, read, or accessed the most number of times as compared to other pages in the cache 158 and creates an outline 154 with widgets that represent the elements in the most-frequently viewed page, where the widgets in the outline 154 are at locations in the outline 154 proportional to the location of the elements in the rendered most-frequently viewed page.

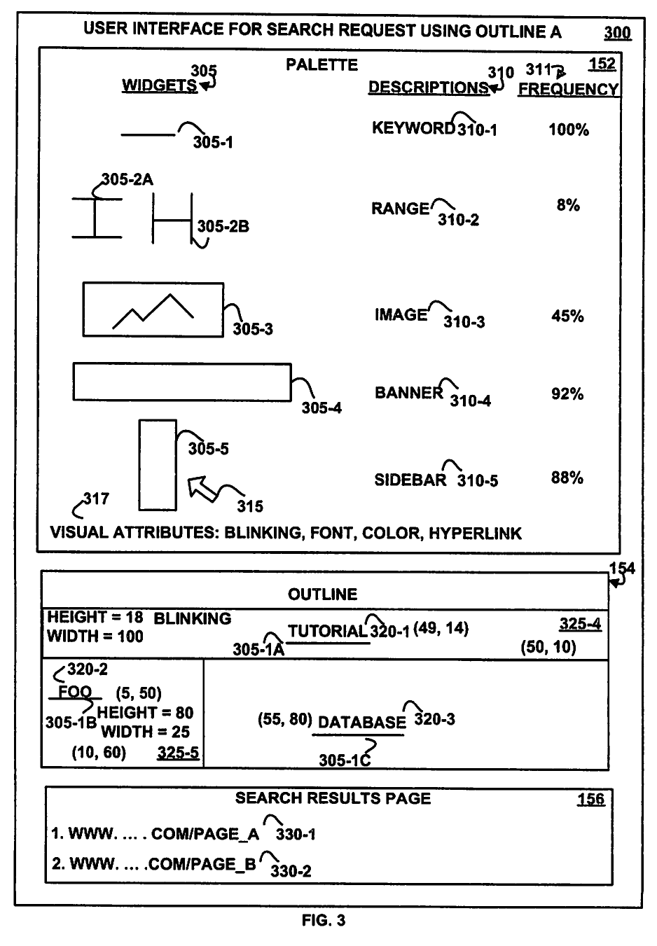

FIG. 3 depicts a block diagram of an example user interface 300 for creating a search request using an outline, according to an embodiment of the invention. The tool 150 displays the user interface 300 via the user terminal 121. The example user interface 300 includes a palette 152, an outline 154, and a search results page 156. The palette 152 includes one or more widgets 305, such as the keyword widget 305-1, the range widgets 305-2A and 305-2B, the image widget 305-3, the banner widget 305-4, and the sidebar widget 305-5. A widget is a user interface element or rendered display area of a page that is visually distinguishable (e.g., via lines, shapes or colors) from other display areas of a page. In addition to the widgets illustrated in FIG. 3, other example widgets include a division, a form, a frame, a title, a button, a check box, a list box, a drop-down list, a radio button, a menu, a context menu, a pie menu, a toolbar, a ribbon, a combo box, an icon, a tree view, a grid view, a tab, a scrollbar, a text box, an edit field, a label, a tooltip, balloon help, a status bar, a progress bar, a window, a modal window, and a dialog box, but in other embodiments any appropriate widget may be used. Widgets are rendered and displayed in pages on video terminals as recognizable forms, but in another embodiment they are stored in pages as control or formatting tags.

The palate 152 further includes one or more descriptions 310, such as the keyword description 310-1, which is associated with and describes the keyword widget 305-1; the range description 310-2, which is associated with and describes the range widgets 305-2A and 305-2B; the image description 310-3, which is associated with and describes the image widget 305-3; the banner description 310-4, which is associated with and describes the banner widget 305-4; and the sidebar description 310-5, which is associated with and describes the sidebar widget 305-5. The widgets 305 generically refers to the widgets 305-1, 305-2A, 305-2B, 305-3, 305-4, and 305-5. The descriptions 310 generically refers to the descriptions 310-1, 310-2, 310-3, 310-4, and 310-5.

The palette 152 further includes an associated frequency 311 for each widget. In an embodiment, the frequency 311 indicates a count of the number of times that the associated widget matches an element contained in a page in the cached pages 158. In another embodiment, the frequency 311 indicates a percentage of the pages in the cached pages 158 that include an element that matches the associated widget. Thus, a high value for the frequency 311 is information that helps guide the user to pick a widget that is most likely to yield helpful search results because that widget has been frequently used in the past.

The palette 152 further includes visual attributes 317, one or more of which the user may select and associate with one or more of the widgets 305. In various embodiments, a visual attribute for a widget may include blinking or flashing, a font, a hyperlink, reverse video, or a color, but in other embodiments any appropriate visual style or attribute may be used. In a reverse video visual attribute (also called inverted video), the color of the background and the text are reversed, causing a portion of the video display screen to appear as a negative of the original display. For example, if the display screen normally displays green images against a black background, a reverse video attribute applied to one particular word displays that word as a black image against a green background.

The palette 152 further includes a pointer 315, which the user may use, via the user terminal 121, to select a subset of the widgets 305 and request (e.g., via a drag an drop operation) that the subset be copied to locations in the outline 154 via a request to the tool 150. The user may further use the pointer 315 to select a subset of the visual attributes 317 and assign the selected subset of the visual attributes to one or more of the widgets in the outline 154 via a request to the tool 150.

The pointer 315 is a graphical image that indicates the location of a pointing device. It can be used to select and move objects or commands. A pointer commonly appears as an angled arrow, but it can vary within different programs, e.g., text-processing applications often use an I-beam pointer that is shaped in the form of a capital “I,” but in other embodiments any appropriate shape or form for a pointer or type of selection or movement technique may be used.

In the example outline 154, the tool 150 has copied the keyword widget 305-1 (in response to drag-and-drop request from the user via the pointer 315 and the terminal 121) from the palette 152 to three keyword widgets 305-1A, 305-1B, and 305-1C at three respective locations within the outline 154, and these three locations are located at the respective coordinates “(49, 14),” “(5, 50)” and “(55, 80).” The tool 150 has further entered the example keywords “tutorial” 320-1, “foo” 320-2, and “database” 320-3 at the location of the respective keyword widgets 305-1A, 305-1B, and 305-1C in the outline 154, in response to user text entry via the terminal 121. The tool 150 has further copied the banner widget 305-4 from the palette 152 to the banner widget 325-4 at the location in the outline that is represented by the coordinates “(50, 10),” representing the middle of the banner widget 325-4, as displayed in the outline 154, in response to a request from the user. The tool 150 has further copied the sidebar widget 305-5 from the palette 152 to the sidebar widget 325-5 at the location in the outline 154 represented by the coordinates “(10, 60),” representing the middle of the sidebar widget 325-5 as displayed in the outline 154, in response to a request from the user. In response to manipulation of the size of the widgets 325-4 and 325-5 via the pointer 315 and the terminal 121, the tool 150 created and/or adjusted the size of the banner widget 325-4 to a height of “18” and a width of “100”) and created and/or adjusted the size of the sidebar widget 325-5 to a size of a height of “80” and a width of “25.”

In an embodiment, the various coordinates are expressed in terms of a Cartesian coordinate system, in which each point in the outline is uniquely identified by a combination of two numbers, which are denoted the x-coordinate and the y-coordinate, respectively, of the point. To define the coordinates, two perpendicular directed lines (the x-axis or abscissa and the y-axis or ordinate), are specified, as well as a unit length, which is marked off on two axes in the page, forming a grid. The point of intersection, where the axes meet, is called the origin, which in the example illustrated in FIG. 3 is the upper left-hand side of the outline. The x and y axes define a plane that is referred to as the xy plane. A particular location within the page is then specified on a two dimensional coordinate system in the form (x, y), an ordered pair, with the x unit first (the abscissa or horizontal unit, followed by the y unit (the ordinate or vertical unit). In other embodiments, locations within the rendered outline 154 may be expressed in terms of a polar coordinate system, or any other appropriate system.

In various embodiments, the unit length of the coordinates may be a relative unit length (e.g., relative to or a percentage of the size of the outline 154 or window in which the outline 154 is displayed) or an absolute unit. Thus, the tool 150 normalizes the coordinates and compares coordinates of keywords to terms based on their relative positions within their respective outline or page. For example, if a keyword is located in an outline at an x coordinate of 25 out of a total outline width of 100, and a term in a rendered page appears at an x coordinate of 200 out of a total page width of 800, the tool 150 normalizes both x coordinates to 25% (thus they are considered to be equal) since they are both 25% of their respective outline or page width.

In an embodiment, the value of the coordinates for a particular widget or keyword may change in response to a change in the size of the outline 154 or the size of the window in which the outline 154 is rendered and displayed via the terminal 121, or the value of the coordinates may remain the same regardless of a change to the size of the outline 154 or the size of the window in which the outline 154 is rendered and displayed. In various embodiments, the unit length of the coordinates may be inches, centimeters, millimeters, pixels, or any other appropriate unit or addressable component of a rendered outline or display device.

In an embodiment, the distance between any two arbitrary locations or points (x₁, y₁) and (x₂, y₂), as well as the height and width of widgets as measured between two points, may be found via the distance formula:

distance=√[(x₂−x₁)²+(y₂−y₁) ].

As illustrated in the example outline 154 of FIG. 3, the keyword widget 305-1A is inside the rendered and displayed banner widget 325-4, i.e., the location of the keyword widget 305-1A at the coordinates “(49, 14)” is located within the displayed area of the banner widget 325-4, as represented by the middle “(50, 10)” of the banner widget 325-4 and the two vertical sides of the banner widget 325-4 having heights of “18” and the two horizontal sides of the banner widget 325-4 having widths of “100.”

As illustrated in the example outline 154 of FIG. 3, the keyword widget 305-1B is inside the rendered and displayed sidebar widget 325-5, i.e., the location of the keyword widget 305-1B at the coordinates “(5, 50)” is located within the displayed area of the sidebar widget 325-5, as represented by the middle “(10, 60)” of the sidebar widget 325-5 and the two vertical sides of the sidebar widget 325-5, having heights of “80,” and the two horizontal sides of the sidebar widget 325-5, having widths of “25.”

As illustrated in the example outline 154 of FIG. 3, the keyword widget 305-1C is outside both the rendered and displayed banner widget 325-4 and the sidebar widget 325-5, i.e., the location of the keyword widget 305-1C at the coordinates “(55, 80)” is located outside the displayed area of the banner widget 325-4 and the displayed area of the sidebar widget 325-5. One or more widgets may be embedded inside another one or more widgets, and so on, indefinitely.

In the example outline 154, the tool 150 has copied the “blinking” visual attribute from the visual attributes 317 in the palette 152 to the banner widget 325-4 in the outline 154, in response to a request from the user, such as a drag-and-drop request via the pointer 315 and the user terminal 121, which assigns the specified visual attribute to the specified banner widget 325-4.

Thus, the outline 154 represents a search request to find a page that includes the keyword “tutorial” 320-1 at the keyword location of coordinates “(49, 14)”; the keyword “foo” 320-2 at the keyword location of coordinates “(5, 50)”; the keyword “database” 305-1C at the keyword location of coordinates “(55, 80)”; a banner widget 325-4 having a middle at the location “(50, 10),” having a height of “18,” and having a width of “100”; and a sidebar widget 325-5 having a middle at the location of coordinates (10, 60), having a height of “80,” and having a width of “25”; where the banner widget 325-4 has a blinking attribute, that is, the banner 325-4 when rendered and displayed has a visual appearance of blinking, flashing, or being displayed intermittently.

The search results page 156 includes identifiers 330-1 and 330-2 of pages that at least partially meet the search request of the outline 154. The search engine 190 sorted the identifiers 330-1 and 330-2 by the degree to which the pages identified by the identifiers 330-1 and 330-2 match the visual presentation of the outline 154. That is, the search engine 190 sorts the identifiers 330-1 and 330-2, according to the degree to which the pages identified by the identifiers 330-1 and 330-2 match the keywords specified by the outline 154, the degree to which the locations of the terms in the pages match the locations of the keywords 320-1, 320-2, and 320-3 in the outline 154, the degree to which the locations of the elements in the pages match the locations of the widgets 325-4 and 325-5 in the outline 154, the degree to which the heights and widths of the pages match the heights and widths of the widgets in the outline 154, and the degree to which the visual characteristics of the elements in the pages match the visual attributes of the widgets in the outline 154, with those pages that more closely match the visual appearance of the outline 154 being displayed nearer to the beginning of the search results page 156 or higher in the sorted list of page identifiers and those pages that less closely match the visual appearance of the outline 154 being displayed further from the beginning of the search results page 156 or lower in the sorted list of page identifiers in the search results page 156.

In various embodiments, the identifiers 330-1 and 330-2 of pages are links, such as a partially or fully-qualified URL (Uniform Resource Locator) or other address that points at a page. A link may include any, some, or all of a specification of a communication protocol, a port identifier, an address on the network 130, a domain identifier, a specification of a hierarchy of directories and subdirectories, and a file name that identifies a file or page within the hierarchy of directories and subdirectories. A page identifier may also include text, such as a title, abstract, or description of the contents of the page at which the link points.

In an embodiment, the tool 150 displays the search results page 156 simultaneously viewable with the outline 154, or the outline 154 and the palette 152, so that the user may request changes to the outline 154 and see the results of those changes reflected in the search results page 156, in the form of different identifiers of different pages or a different sort order of the identifiers.

FIG. 4 depicts a block diagram of example pages 138, according to an embodiment of the invention. The pages 138 may include any number of pages, such as the example pages 138-1, 138-2, and 138-3. The example page A 138-1, page B 138-2, and page C 138-3 are illustrated as rendered and displayed on a user terminal analogous to the user terminal 121. The page 138-1 includes rendered elements 405-1 and 410-1. The element 405-1 is an example of a banner element. The rendered element 405-1 is located at coordinates “(50, 10)” within the page 138-1 and has a height of “20” and a width of “100” and does not have any listed visual characteristics. The element 410-1 is an example of a sidebar element. The rendered sidebar element 410-1 is located at coordinates “(10, 70)” within the page 138-1 and has a height of “70” and a width of “20” and does not have any listed visual characteristics. The page 138-1 further includes a rendered term 420-1 at a term location of coordinates “(50, 10),” a rendered term 420-2 at a term location of coordinates “(5, 20),” and a rendered term 420-3 at a term location of coordinates “(38, 65).”

The page 138-2 includes rendered elements 405-2 and 410-2. The element 405-2 is an example of a banner element. The rendered element 405-2 is located at coordinates “(50, 10)” within the page 138-2 and has a height of “25” and a width of “90” and does not have any listed visual characteristics. The element 410-2 is an example of a sidebar element. The rendered element 410-2 is located at coordinates “(8, 72)” within the page 138-2 and has a height of “70” and a width of “18” and does not have any listed visual characteristics. The page 138-2 further includes a rendered term “tutorial” 420-1 at a term location of coordinates “(85, 12)” within the page 138-2, a rendered term “foo” 420-2 at a term location of coordinates “(3, 15)” within the page 138-2, and a rendered term “database” 420-3 at a term location of coordinates “(95, 95)” within the page 138-2.

The page 138-3 includes no rendered elements, but does include a rendered term “tutorial” 420-1 at a term location of coordinates “(70, 95),” a rendered term “foo” 420-2 at a term location of coordinates “(95, 40),” and a rendered term “database” 420-3 at a term location of coordinates “(10, 95).”

Although all of the example pages 138-1, 138-2, and 138-3 include the same example terms 420-1, 420-2, and 420-3, the terms have different term locations within their respective rendered pages and the pages 138-1, 138-2, and 138-3 include different elements with different heights, widths, and locations. Thus, search requests that are represented by different outlines with different keyword locations and different widgets, different widget locations, different widget heights, and widget widths may return different identifiers of pages in the search results, and identifiers of pages within the search results may be sorted in an different order, even if the search requests in the different outlines specify identical keywords.

In an embodiment, the location coordinates, heights, and widths of the elements and terms in the pages 138 are expressed in terms of a Cartesian coordinate system, as previously described above with reference to FIG. 3, but in other embodiments, a polar coordinate system or any appropriate system may be used.

FIG. 5 depicts a block diagram of an example data structure for the index 192, according to an embodiment of the invention. The crawler 194 creates the index 192, as further described below with reference to FIG. 6. The index 192 includes any number of page entries 502, one for each indexed page 138. Each page entry 502 includes a page address 505, a term list 510, a title 515, an abstract 520, page popularity 525, and an element list 530, although in other embodiments more or fewer elements within a page entry may be present.

The page address 505 includes the URL or other address of the page 138 at the server computer system 135 that the respective page entry 502 represents. The term list 510 includes a list of term entries 535 for each term in the page 138 identified by the page address 505. Each term entry 535 includes a term 540, a term rendered location 550, and an embedded-in element 552. The term 540 includes a word or collections of words present in the page 138 identified by the page address 505. The term rendered location 550 indicates the location that the term 540 appears in the page pointed at by the page address 505 when the page is rendered. In various embodiments, the term rendered location 550 may be expressed in coordinates, as a pixel in a bitmap, or via any other appropriate technique. The embedded-in element 552 identifies an element 560 in which the term 540 is embedded or contained. For example, a term may be embedded in a banner, a sidebar, an image, a label, or any other element.

The title 515 and the abstract 520 may be any text, audio, video, or image that describe the page at the associated page address 505. In another embodiment, the index 192 may include any portion or all of the page pointed at by the page address 505. The page popularity 525 indicates a relative importance of the page 138 at the address 505, as compared to other of the pages described by the index 192.

The element list 530 includes any number of element entries 555, each of which includes an element 560, an element rendered location 565, an element rendered height 570, an element rendered width 575, visual characteristics 580 for the element 560, and an embedded-in element 582. Each of the element entries 555 represents a control or formatting tag in the page 138 that is pointed at by the page address 505 and that is represented by the page entry 502. Control or formatting tags provide information that controls the rendering, formatting, or presentation of the page when interpreted by the tool 150, a browser, or other program. Examples of tags include range tags, banner tags, sidebar tags, anchor tags, paragraph tags, font tags, or any other appropriate type of tag. The element rendered location 565 specifies the location of the respective element 560 within the page located at the page address 505 when rendered. The element rendered height 570 specifies the vertical height of the rendered element 560 within the rendered page located at the page address 505 when rendered. The element rendered width 575 specifies the horizontal width of the rendered element 560 within the rendered page located at the page address 505 when rendered. The visual characteristics 580 specifies the visual characteristics of the element 560 when displayed, such as blinking element, a font in which text within the element is displayed, a color or hue of the displayed element, or an indication that the element includes a hyperlink when displayed. The embedded-in element 582 identifies another element in which the element 560 is embedded or contained. For example, an image element may be embedded inside a banner element or a sidebar element.

FIG. 6 depicts a flowchart of example processing for the crawler 194, according to an embodiment of the invention. The processing of FIG. 6 is performed periodically, so that the crawler 194 may crawl and process any pages 138 that have been added to the server computer systems 135 or modified since the last time that the crawler 194 crawled the pages 138.

Control begins at block 600. Control then continues to block 605 where the crawler 194 enters a loop that is executed once for each page 138. The crawler 194 may crawl all pages 138 or a subset of the pages 138. So long as more pages 138 or a next page remain to be crawled by the logic of FIG. 6, control continues from block 605 to block 610 where the crawler 194 retrieves the next page (now the current page) 138 from a server computer system 135.

Control then continues to block 615 where the crawler 194 adds the current page 138 to the index 192. Adding the current page 138 to the index 192 includes storing the address for the current page 138 into the page address 505, selecting and storing the terms that exist in the current page 138 into the term entries 535 of the index 192, calculating and storing the term rendered locations 550 for the selected terms into the index 192, and selecting and storing information that describes the tags in the page into the element entries 555, including the element 560, the element rendered location 565, the element rendered height 570, the element rendered width 575, the visual characteristics 580 of the element, and the embedded-in element 582. The crawler 194 may further select and store information from the page, such as the title 515, the abstract 520, or may store some or all of the page 138. The crawler 194 determines the locations 550 and 565, the element rendered height 570, and the element width 575 based on a default window size in which the page is rendered.

The crawler determines that a term 540 is embedded in an element 560 by comparing the term rendered location 550 to the element rendered location 565, the element rendered height 570, and the element rendered width 575. If the term rendered location 550 is within the circumference of the element as defined by the element rendered location 565, the element rendered height 570, and the element rendered width 575 (height and width specify an area having a circumference around the location), then the crawler 194 adds a specification of the element 560 to the embedded-in element 552 for the term 540. A term 540 may have more than one embedded-in element since elements may be embedded inside one another.

The crawler 194 determines that one element is embedded in another element by calculating the rendered area of the elements from their respective element rendered locations 565, respective element rendered heights 570, and respective element rendered widths, and by determining that the rendered area of one element is completely or partially within the rendered area of another element. If the area of a rendered element, as defined by its element rendered location 565, element rendered height 570, and element rendered width 575, is completely or partially within the circumference of another element, then the crawler 194 adds a specification of the larger element that embeds or contains the smaller element to the embedded-in element 582 for the smaller element. An element may have more than one embedded-in element 582 since elements may be embedded inside one another, indefinitely.

The crawler 194 may use any appropriate technique for selecting the terms 540. For example, in an embodiment the crawler 194 may choose to ignore short, common words in the page 138 (e.g., “a,” “and,” and “the”), and not store these words in the terms 540.

In various embodiments, the crawler 194 may select the terms 540 from the page 138 via closed caption tags, transcripts, and voice recognition techniques for analyzing audio or audio with video. But, in other embodiments, the crawler 194 may use any appropriate technique for selecting the terms from the page 138 to store in the terms 540.

Control then returns to block 605 where the crawler 194 determines whether another page still exists to be crawled, as previously described above.

If the crawler 194 has crawled every page 138 or every page in a subset of the pages 138, then control continues from block 605 to block 625 where the crawler 194 calculates the page popularities 525 for every page 138 in the index 192. In an embodiment, the crawler 194 may use either or both of on-the-page criteria or off-the-page criteria to determine the page popularities 525.

On-the-page popularity criteria may include the relative importance or significance of the terms 540 in the various pages described by the index 192 as compared to other terms. The crawler 194 may determine the importance based on the location on the page (pointed to by the address 505) of the term 540 and/or the frequency that the associated term 540 appears on the page 138. For example, the crawler 194 may assign a higher importance to terms that appear in a title or header because the crawler 194 assumes that terms in the title or header are more relevant or more important than terms appearing in other locations in the page. Further, the crawler 194 may also assign a higher importance to terms that appear near the top of the page, such as in the headline or in the first few paragraphs of text because the crawler 194 assumes that any page relevant to the topic will mention those words at the beginning. Further, the crawler 194 may also assign a higher importance to terms that appear in a larger font size than terms that appear in a smaller font size because the crawler 194 assumes that terms displayed in a larger font are more important than terms displayed in a smaller font. The crawler 194 may also assign a higher importance to terms that appear in a meta tag. The crawler 194 may also analyze how often terms appear in relation to other words in the page and assign a higher importance to those terms 540 that appear more frequently.

Off-the-page popularity criteria use data external to the page itself. An example of an off-the-page popularity criteria is link analysis, in which the crawler 194 analyzes how pages link to each other to determine the relative importance of the page with respect to other pages. For example, the crawler 194 may assign a higher page popularity 525 to a page with many incoming links (a page to which many other pages link because such a page is probably an important page). In addition, the crawler 194 may use recursive page-popularity where the page popularity 525 of the pages that link to the linked-to page also factors into the popularity of the linked-to page. The page popularity 525 is a numeric value that represents how important the page is, as compared to all other pages described in the index 192. Page popularity 525 is based on the idea that when one page links to another page, it is effectively casting a vote for the other page. The more votes that are cast for a page, the more important the page. Also, in an embodiment, the importance of the page that is casting the vote determines how important the vote itself is.

Control then continues to block 699 where the logic of FIG. 6 returns.

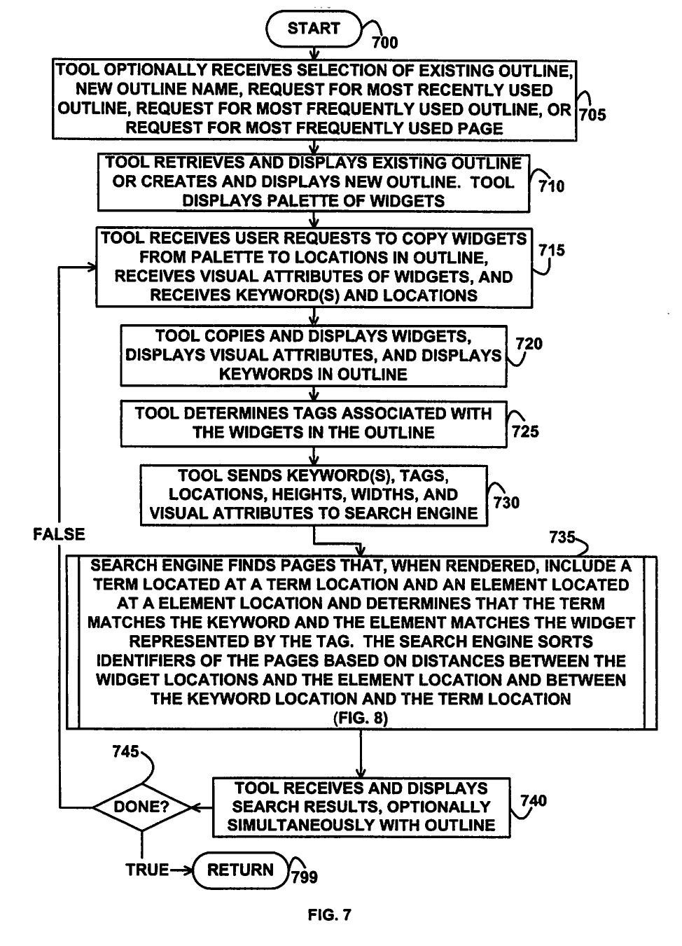

FIG. 7 depicts a flowchart of example processing for building the outline, according to an embodiment of the invention. Control begins at block 700. Control then continues to block 705 where the tool 150 optionally receives selection of an existing outline via the option 205, receives a selection of a new outline name via the create option 210, receives a request for a most-recently used outline via the option 215, receives a request for the most-frequently used outline via the option 220, or receives a request for the most-frequently used page via the option 225.

Control then continues to block 710, where in response to the selection of block 705, the tool 150 finds, retrieves, and displays an existing outline or creates and displays a new outline via the user terminal 121. The tool 150 further displays the palette 152 of available widgets on the user terminal 121, including the available widgets 305, the available descriptions 310, the available visual attributes 317 for the widgets 305, and the frequency 311 that the elements corresponding to the widgets occur in the cached pages 158.

If the create new outline name option 210 is selected with a based-on page option 212 selected and a page name, address, or identifier specified, then the tool 150 receives the name, address, or other identifier of the specified page from the user interface 200, retrieves the specified page (from the cached pages 158 or the pages 138), reads the embedded elements in the specified page, creates the new outline with widgets corresponding to the embedded elements, determines the rendered locations of the elements, and creates the widgets in the outline at locations corresponding to the rendered locations of the embedded elements in the specified page.

For the most-frequently used page option 225, the tool 150 searches the cached pages 158 and finds the page that was most frequently retrieved, downloaded, viewed, or accessed (as compared to the other pages in the cached pages 158), reads the elements embedded in that page, renders the elements, determines the locations of the rendered elements, and displays the rendered elements as widgets at the determined locations in the outline 154. Thus, the tool 150 creates the outline 154 to represent the visual nature (the elements and their locations) of the most-frequently viewed page, which allows the user to request a search for pages that have a similar visual appearance as the most-frequently viewed page.

Control then continues to block 715 where the tool 150 receives a specification of one or more of the widgets from the palette 152, widget locations for the widgets in the outline 154, one or more keywords, and one more keyword locations in the outline 154 for the keywords. The widgets are selected and specified from among the widgets in the displayed palette 152, e.g., by the user dragging and dropping a selected widget from the palette 152 to a widget location within the outline 154 by operation of a pointing device, the pointer 315, and the user terminal 121. The tool 150 further optionally receives a specification of one or more of the visual attributes 317 and an identification of one or more of the respective selected widgets displayed in the outline 154 that are to receive the specified visual attribute.

Control then continues to block 720 where the tool 150 copies the selected widgets and their associated visual attributes, if any, from the palette 152 to the outline 154 and displays the selected widgets with their selected visual attributes in the specified widget locations in the outline 154. The tool 150 further changes the heights and/or widths of the widths of the displayed widgets in the outline 154, in response to resize requests from the user, e.g., via the user dragging the edges of the horizontal and/or vertical sides of the widgets via the pointing device of the user terminal 121 and the pointer 315. The tool 150 further displays the entered keywords (which may be entered by the user via an input device of the terminal 121) in the outline 154 in the specified keyword locations. Control then continues to block 725 where the tool 150 determines the control or formatting tags that are associated with the widgets that are displayed in the outline 154. Control then continues to block 730 where the tool 150 builds and sends a search request represented by the outline 154 to the search engine 190. The search request represented by the outline 154 includes the keywords, the determined tags or widgets, the rendered widget locations within the outline, the keyword locations within the outline 154, the heights and widths of the rendered widgets, and the selected visual attributes of the rendered widgets within the outline. In an embodiment, the search request also includes the dimensions (height and width) of the window in which pages are displayed on the video display screen of the user terminal 121.

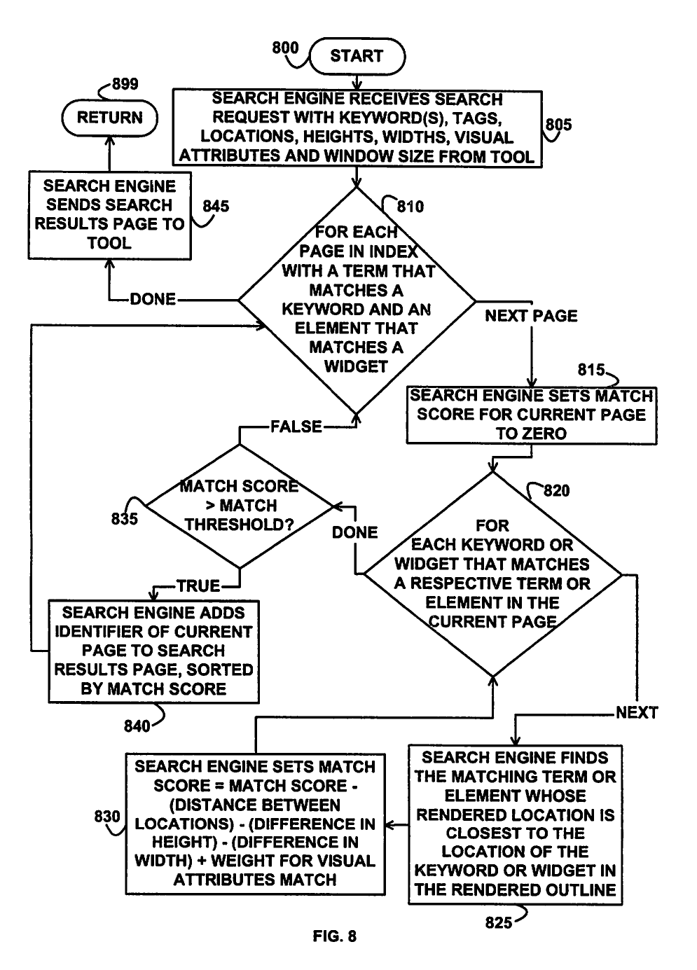

Control then continues to block 735 where the search engine 190 receives the search request represented by the outline, and in response finds the pages that each, when rendered, include a term located at a respective term location and an element located at a respective element location, where the term matches the keyword and the element matches the widget, as further described below with reference to FIG. 8. The search engine 190 further sorts identifiers of the found pages based on distances between the widget location and the element location and distances between the keyword location and the term location, as further described below with reference to FIG. 8. The search engine 190 further sorts the identifiers for the found pages based on a determination of whether or not a visual characteristics for an element in the found page matches a visual attribute for a widget (the widget that matches the element) in the outline 154. In an embodiment, the search engine 190 calculates the distances by rendering the outline 154, rendering the page, superimposing the rendered outline 154 and rendered page together, and calculating the distances as if the rendered outline 154 and the rendered page exist on the same xy plane.

Control then continues to block 740 where the tool 150 receives the sorted search results page 156 from the search engine 190 and displays the search results page 156 via a video display device of the user terminal 121. The tool 150 optionally displays the search results 156, so that they are simultaneously viewable with the outline 154. Control then continues to block 745 where the tool 150 determines whether the user is done modifying the outline 154.

If the determination at block 745 is true, then the user is done modifying the outline 154, so control continues to block 799 where the logic of FIG. 7 returns.

If the determination at block 745 is false, then the user is not done modifying the outline 154, so control returns to block 715 where the tool 150 optionally receives further requests from the user to copy widgets from the palette 152 to widget locations in the outline 154, and optionally receives further visual attributes of the widgets and optionally receives further keywords and keyword locations, while the previous search results 156 and the outline 154 are simultaneously viewable on the user terminal 121, as previously described above.

FIG. 8 depicts a flowchart of example processing for performing a search specified by an outline by the search engine, according to an embodiment of the invention. Control begins at block 800. Control then continues to block 805 where the search engine 190 receives an outline representing a search request with keyword(s), rendered locations within the outline 154 of the respective keywords, the tags that represent widgets or the widgets within the outline 154, locations of the rendered widgets in the outline 154, the heights and widths of the rendered widgets within the outline 154, and the visual attributes, if any, of the rendered widgets in the outline 154. In an embodiment, the received search request also includes the dimensions (the height and width) of the window in which pages are displayed on the video display screen of the user terminal 121.

Control then continues to block 810 where the search engine 190 starts a loop that executes once for each page in the index 192 that includes a term 540 that matches (is the same as) a search keyword (in the outline 154) and that includes an element 560 that matches (is the same as) the widget (in the outline 154) represented by the received tag. So long as the determination at block 810 is true, then a current page exists that has not yet been processed by the loop that starts at block 805 and the current page contains a term 540 that matches a search keyword and the current page includes an element 560 that matches the widget represented by the received tag, so control continues to block 815 where the search engine 190 initializes a match score for the current page to zero.

Control then continues to block 820 where the search engine 190 starts a loop that executes once for each search keyword in the outline 154 that matches a respective term 540 in the current page and once for each widget that matches a respective element 560 in the current page. Thus, the loop executes once for each matching keyword and once for each matching widget. So long as the determination at the block 820 is true, then a current matching keyword or matching widget exists that has not yet been processed by the loop that starts at block 820, so control continues to block 825 where the search engine 190 searches for and finds the term 560 in the current page that matches the search keyword whose rendered location in the outline 154 is closest (the shortest distance) to the location 550 of the matching term 560 in the current page, or the search engine 190 finds the rendered element 560 in the current page whose rendered location 565 (in the page) is closest (the shortest distance) to the rendered location of the rendered widget in the rendered outline 154. The tool 150 calculates the distances by rendering the outline 154, rendering the page, superimposing the rendered outline 154 and rendered page together, and calculating the distances between the locations as if the rendered outline 154 and the rendered page exist on the same plane. In an embodiment, the distance between any two arbitrary locations or points (x₁, y₁) and (x₂, y₂) of the widgets, elements, keywords, and terms, as well as the height and width of widgets and elements as measured between two points, may be found via the distance formula:

distance=√[(x₂−x₁)²+(y₂−y₁)²], where “√” represents the square root function.

Control then continues to block 830 where the search engine 190 sets the match score for the current page to be the match score thus far minus (the distance between the location of the current matching keyword in the rendered outline 154 and the location 550 of current matching term 540 in the rendered page) if the current loop iteration is processing the matching keyword. If the current loop iteration is processing the matching widget, then the search engine 190 sets the match score to be the match score thus far minus (the difference between the height 570 of the current rendered element and the height of the current rendered widget) minus (the difference between the width 575 of the current rendered element and the width of the current rendered widget) plus (a weight associated with a determination of whether the visual attributes of the widget match the visual characteristics of the element if the visual attributes and characteristics exist). In an embodiment, the weight is “1” if the visual attributes and the visual characteristics match and “0” if they do not match, but in other embodiments any weight that is greater when the attributes and characteristics match than when they do not match may be used.

Control then returns to block 820 where the search engine 190 moves the current matching keyword or matching widget to the next matching keyword or widget, as previously described above. Once all matching keywords and widgets for the current page have been processed, then the loop that starts at block 820 is done, so control continues from block 820 to block 835 where the search engine 190 determines whether the current page match score is greater than a match threshold value. In various embodiments, the match threshold may be fixed or variable. The search engine 190 may vary the match threshold, in order to adjust the number of identifiers in the search results to be manageable and useful for the user. For example, in an embodiment, the search engine 190 changes the match threshold in proportion to the number of pages that include a term that matches the keyword, in proportion to the number of elements in the page, in proportion to the number of search keywords, or based on any other appropriate criteria. In another embodiment, the search engine 190 modifies the match score based on the page popularity, increasing the match score if the page popularity is high and decreasing the match score if the page popularity is low.

If the determination at block 835 is true, then the match score for the current page is greater than a match threshold value, so control continues from block 835 to block 840 where the search engine 190 adds the identifier that points at the current page to the search results page 156, sorted or ordered by the match scores of the identifiers in the search results page 156. Thus, in an embodiment, the search engine 190 sorts the identifiers of the pages based on differences between widths and heights of the widgets in the outline 154 and the elements in the page. In an embodiment, the search engine 190 sorts the identifiers of the pages based on matches between the visual attributes of the widgets and the visual characteristics of the elements. In an embodiment, the search engine 190 sorts the identifiers of the pages based on differences between the locations of the keywords and the terms. In an embodiment, the search engine 190 sorts the identifiers of the pages based on differences between the locations of the widgets and the elements.

Control then returns to block 810 where the search engine 190 sets the current page to be the next page that includes a term 540 that matches a keyword and that includes an element that matches a widget, as previously described above.

If the determination at block 835 is false, then the current page match score is not greater than the match threshold, so an identifier of the current page is not added to the search results page 156, and control returns from block 835 to block 810, as previously described above.

When all pages that are described in the index 192 and that include a term 540 that matches a search keyword and that include an element 560 that matches a widget have been processed by the loop that starts at block 810, then the loop is done, so control continues from block 810 to block 845 where the search engine 190 sends the search results page 156 to the tool 150, which is the requester or the initiator of the search request. Control then continues to block 899 where the logic of FIG. 8 returns.

In an embodiment, when rendering the pages, the search engine 190 calculates the term and element location coordinates based on the window size or dimensions that were included in the search request. That is, the search engine 190 adjusts the location and size coordinates (550, 565, 570, 575) of terms and elements in proportion to the locations where the terms would be rendered in a window of the received dimensions. This adjustment is helpful because the user's view of a page is different depending on the window size or video screen size, e.g., a small video display screen versus a large video display screen monitor.

In another embodiment, the search engine 190 creates the search results 156 using the location and size coordinates (550, 565, 570, and 575) specified in the index. The search engine 190 then re-renders the pages identified in the search results 156 using the window dimensions specified in the request, adjusting the location and size coordinates (550, 565, 570, 575) of terms and elements in proportion to the locations where the terms would be rendered in a window of the received dimensions. The search engine 190 then orders the identifiers in the search results 156 by match score. In this embodiment, the search engine 190 only re-renders (based on the window dimensions in the search request) those pages that are identified in the search results 156.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving a specification of a first widget, a first widget location, a keyword, and a keyword location;
finding a plurality of pages that each, when rendered, comprise a term located at a respective term location and an element located at a respective element location, wherein the term matches the keyword and the element matches the first widget; and
sorting identifiers of the plurality of pages based on distances between the first widget location and the element location and between the keyword location and the term location.

2. The method of claim 1, further comprising:
sending the identifiers to a requester in response to the sorting.

3. The method of claim 1, wherein the keyword location is inside the first widget.

4. The method of claim 1, wherein the keyword location is outside the first widget.

5. The method of claim 1, wherein the sorting further comprises:
sorting the identifiers of the plurality of pages based on differences between widths and heights of the first widget and the element.

6. The method of claim 1, further comprising:
displaying a palette comprising a plurality of widgets, wherein the receiving the specification of the first widget further comprises receiving the specification of the first widget from among the plurality of widgets.

7. The method of claim 6, wherein the displaying the palette further comprises:
displaying the palette comprising a plurality of visual attributes, wherein the receiving the specification of the first widget further comprises receiving a specification of one of the plurality of visual attributes for the first widget.

8. The method of claim 7, wherein the sorting further comprises:
sorting the identifiers of the plurality of pages based on matches between the one of the plurality of visual attributes for the first widget and a visual characteristic for the element.

9. The method of claim 2, wherein the sorting further comprises:
calculating the term location and the element location based on a window size of the requester.

10. A storage medium encoded with instructions, wherein the instructions when executed comprise:
receiving a specification of a first widget, a first widget location, a keyword, and a keyword location;
displaying the first widget at the first widget location in an outline;
displaying the keyword at the keyword location in the outline;
finding a plurality of pages that each, when rendered, comprise a term located at a respective term location and an element located at a respective element location, wherein the term matches the keyword and the element matches the first widget;
sorting identifiers of the plurality of pages based on distances between the first widget location and the element location and between the keyword location and the term location; and
displaying the identifiers of the plurality of pages in response to the sorting.

11. The storage medium of claim 10, wherein the sorting further comprises:
sorting the identifiers of the plurality of pages based on differences between widths and heights of the first widget and the element.

12. The storage medium of claim 10, further comprising:
displaying a palette comprising a plurality of widgets, wherein the receiving the specification of the first widget further comprises receiving the specification of the first widget from among the plurality of widgets.

13. The storage medium of claim 10, wherein the receiving the specification of the first widget and the first widget location further comprises:
receiving a specification of a first page;
reading a first element from the first page;
determining a first rendered location of the first element; and
creating the first widget from the first element and the first widget location from the first element.

14. The storage medium of claim 10, wherein the sorting further comprises:
receiving a specification of a visual attribute for the first widget; and
sorting the identifiers of the plurality of pages based on matches between the visual attribute for the first widget and a visual characteristic for the element.

15. The storage medium of claim 10, wherein the outline and the identifiers are simultaneously viewable and wherein the identifiers are updated in response to a change to the keyword, the keyword location, the first widget, and the first widget location.

16. A computer system comprising:
a processor; and
memory connected to the processor, wherein the memory encodes instructions that when executed by the processor comprise:
displaying a palette comprising a plurality of widgets,
receiving a selection of a subset of the plurality of widgets, a plurality of widget locations, a keyword, and a keyword location,
displaying the subset at the plurality of widget locations in an outline,
displaying the keyword at the keyword location in the outline,
finding a plurality of pages that each, when rendered, comprise a term located at a respective term location and a plurality of elements located at a plurality of respective element locations, wherein the term matches the keyword and the plurality of elements match the subset,
displaying identifiers of the plurality of pages in a sorted order based on distances between the subset of the plurality of widget locations and the plurality of element locations and between the keyword location and the term location.

17. The computer system of claim 16, wherein the sorting further comprises:
sorting the identifiers of the plurality of pages based on differences between widths and heights of the subset of the plurality of widget locations and the element.

18. The computer system of claim 16, wherein one of the subset of the plurality of widgets is located inside another of the subset of the plurality of widgets.

19. The computer system of claim 16, wherein the instructions further comprise:
receiving a specification of visual attributes for the subset; and
sorting the identifiers of the plurality of pages based on matches between the visual attributes for the subset and visual characteristics for the plurality of elements.

20. The computer system of claim 16, wherein the displaying the palette further comprises:
displaying a frequency that one of the plurality of elements associated with one of the plurality of widgets occurred in cached pages.
